(19) United States
(12) Patent Application Publication
(10) Pub. No.: US 2008/0303182 A1
(43) Pub. Date: Dec. 11, 2008

(54) Method for Producing Panels of Thermoplastically Extruded Synthetic Materials

(76) Inventor: Walter Breyer, Rielasingen (DE)

Correspondence Address: BACHMAN & LAPOINTE, P.C., 900 CHAPEL STREET, SUITE 1201, NEW HAVEN, CT, 06510, US

(21) Appl. No.: 11/659,048

(22) PCT Filed: Jun. 9, 2005
(86) PCT No.: PCT/EP05/06218

§ 371 Date: Jan. 31, 2007

(30) Foreign Application Priority Data
Aug. 6, 2004 (DE) 10 2004 038 571.8

(51) Int. Cl. B29C 47/34

(52) U.S. Cl. 264/151; 425/114

(57) ABSTRACT

A method for the production of plates of thermoplastically extruded synthetic materials, particularly for TFT screens, wherein the plates are extruded in a conical manner. The conically extruded panels are extruded in a polishing stack, such as a three-roll polishing stack. At least one roll of the stack may have a conical profile.

### BACKGROUND

(1) Field of the Invention

The present invention relates to a method for producing panels of thermoplastically extruded synthetic materials, in particular for TFT screens, and to an apparatus for carrying out the method.

(2) Prior Art

In the thermoplastic extrusion of synthetic materials, it has so far only been possible to produce panels that are as homogeneous as possible and of the same thickness in very thin ranges. These panels are of small thickness and are produced by the extrusion process. The procedure involved is that synthetic material is extruded and passed by means of an extrusion die to a polishing stack, and then, in the polishing stack, the panel is smoothed out to the appropriate thickness, homogenized, cooled and passed to a roller conveyor, and is then correspondingly cut off to a desired length.

In the production of TFT monitors, panels of synthetic material are also used as lighting elements, which in the case of notebooks are formed in a conically tapered manner. These are produced by casting liquid synthetic material in correspondingly formed moulds. Production of this kind is very expensive, costly and does not ensure the appropriate, requisite surface qualities.

### SUMMARY OF THE INVENTION

The present invention is therefore based on the object of improving a method and an apparatus for carrying out the method that overcome the aforementioned disadvantages and allow diverse production of various panels of a wide variety of kinds that are of high surface quality and homogeneity in a very simple and low-cost way.

In the case of the present invention, it has proven to be particularly advantageous that at least one of the rolls of the polishing stack is formed in a profiled manner, in order to produce conical panels, or panels that extent in a conical manner or are formed in a tapered manner, by extrusion of thermoplastic synthetic materials in a continuous production process.

In order that pressure distribution or distribution of the liquid, extruded thermoplastic synthetic material is possible, preferably two conically tapered regions are provided as profiling in at least one roll of the polishing stack, it being possible for the conically tapered regions to be formed such that they are outwardly or inwardly directed.

In order then to obtain a panel with a single conically tapered region, the panel with two conically tapered regions is then separated, preferably centrally. Two individual panels are thereby obtained.

Extrusion of conical panels is not readily possible. For this purpose, various parameters must be additionally taken into account, in order to obtain a conically tapered panel that does not warp, is of high surface quality and has a homogeneous, low-stress microstructure.

It has proven to be advantageous in the case of the present invention to provide a number of profiled regions in one or more rolls of the polishing stack. It may also be that the last rolls of the polishing stack are formed in a correspondingly profiled manner. The same then also applies to the roller conveyor following thereafter, which likewise has profiled rollers, in order to take over the profiled panels and pass them to a mechanism for cutting them to length.

Furthermore, it has proven to be particularly advantageous that an outlet cross section of an extrusion die is adapted to a cross-sectionally profiled or conically formed profile of panels. Furthermore, influence is likewise brought to bear on a changing cross section by means of appropriate different temperature control of the extrusion die or of the extrusion die body in different regions. In particular, additional heating of the material is performed in the die body in regions of the panel that are thicker in cross section than in the tapered, thinner regions.

Something similar takes place during cooling in the polishing stack, cooling being performed to an appropriately greater degree in the thicker regions of the panels than in the tapered conical regions.

In the case of the present invention, it has even proven to be advantageous to reheat the conically tapered regions if need be, so that homogeneous cooling is performed over the entire panel cross section. These advantages make it possible for conical panels that can be used for example as lighting elements for TFT monitors for notebooks to be produced by the extrusion process.

### BRIEF DESCRIPTION OF THE DRAWINGS

Further advantages, features and details of the invention emerge from the following description of preferred exemplary embodiments and with reference to the drawing, in which:

FIG. 1 shows a schematically represented side view of a three-roll polishing stack for the extrusion of thermoplastic synthetic materials with a roller conveyor following thereafter;

FIGS. 2a and 2b show a schematically represented cross section through a conically extending panel of thermoplastically extruded synthetic material, in particular for use of TFT screens as a lighting element, in particular for notebooks;

FIG. 3a shows a schematically represented plan view of a possible way of forming and arranging two adjacent rolls of a roll polishing stack for the thermoplastic extrusion of synthetic material;

FIG. 3b shows a schematically represented cross section through a synthetic material panel with two end regions running out conically;

FIG. 4a shows a schematically represented plan view of two rolls of a roll polishing stack for the extrusion of thermoplastic synthetic materials for forming conically extending panels;

FIG. 4b shows a schematically represented cross section through a thermoplastically extruded panel with two regions extending conically in relation to one another;

FIG. 5a shows a schematically represented plan view of two profiled rolls for the extrusion of thermoplastic panels with two conically tapered end regions;

FIG. 5b shows a panel of thermoplastically extruded synthetic material with two respectively outwardly tapered conically extending regions;

FIG. 6a shows a schematically represented plan view of two adjacent profiled rolls for producing a number of panels of thermoplastically extruded synthetic materials arranged axially next to one another, which respectively have conically tapered regions;

FIG. 6b shows schematically represented cross sections through two panels with respectively conically tapered end regions.

### DETAILED DESCRIPTION OF THE PREFERRED EMBODIMENT(S)

According to FIG. 1, an apparatus R for the thermoplastic extrusion of synthetic materials 3, in particular panels 6, has a polishing stack 1 (only schematically represented here), which in the preferred exemplary embodiment is formed as a three-roll polishing stack, with the rolls W₁, W₂ and W₃. Thermoplastic synthetic material 3, extruded by means of an extrusion die 2, is introduced between the rolls W₁ and W₂. The synthetic material 3 wraps around the roll W₂ and is continuously delivered around a further roll W₃ onto a roller conveyor 4 (only indicated here) with rollers 5.

The polishing stack 1 serves essentially for setting a panel thickness, for homogenizing the synthetic material, for cooling and for improving the surfaces of the synthetic material 3 extruded into elongate panels 6.

In certain areas, in particular in the production of TFT monitors, in particular for notebooks, conically extending synthetic material panels are required as lighting elements, since the actual one-sided lighting takes place in the thicker region of the conically extending panel.

It has so far not been possible to form thermoplastically extruded synthetic material as a thin conical panel.

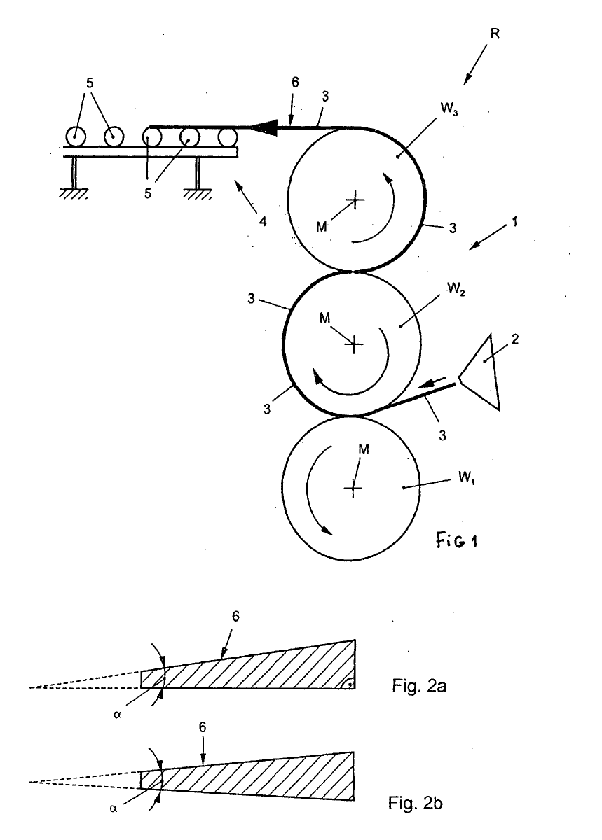

In FIGS. 2a and 2b, two conically extending panels 6, which can be used for example for producing lighting elements for TFT notebook monitors, are cross-sectionally shown. The corresponding lighting means (not represented any more specifically here) for the lighting element is then located in the lateral, thicker region.

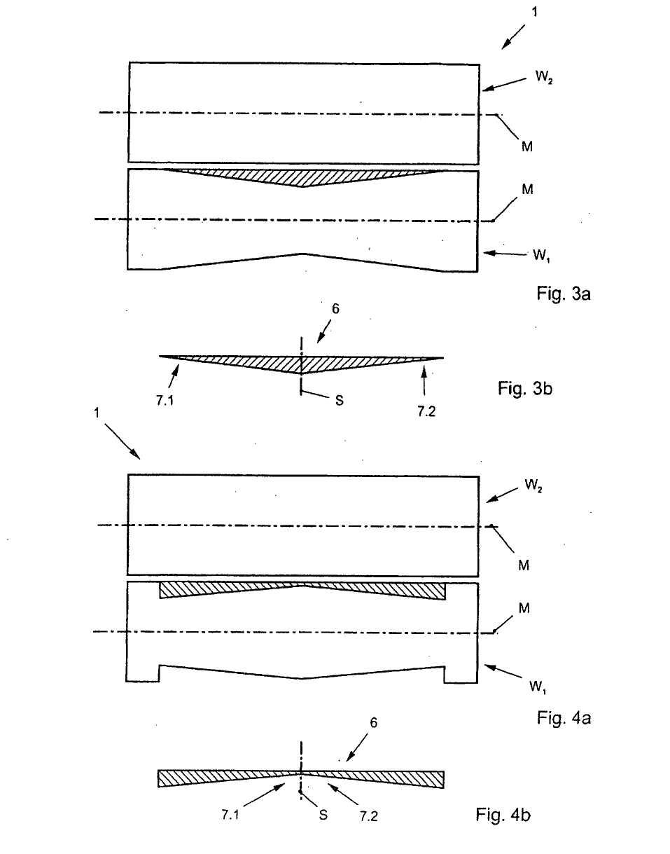

In order to produce these panels from thermoplastically extruded synthetic materials, it has proven to be particularly advantageous in the case of the present invention, as represented in particular in FIG. 3a, to profile appropriately at least one roll W₁ and/or W₂ of the polishing stack 1 (only partly indicated here), so as to form a panel 6, as cross-sectionally represented in FIG. 3b, that respectively has two regions 7.1, 7.2 extending conically to the end. In order then to obtain corresponding panels 6, as represented in FIG. 2a, after being produced they are severed in the cutting line S represented into two panels 6 respectively with regions 7.1 and 7.2 tapered conically to the end.

This ensures that conical extrusion is possible in the first place, since the liquid, thermoplastic material, as a result of the appropriate profiling of the rolls W₁, W₂, which respectively rotate about the central axes M, possible in the first place, since the liquid thermoplastic material cannot escape at the sides.

In the exemplary embodiment of the present invention according to FIG. 4a, the profiling is correspondingly formed in such a way that the conical tapering or profiling ends in a central region of the roll W₁, W₂, and, as represented in particular in FIG. 4b, the conical regions 7.1, 7.2 of the panel 6 are aligned such that they are on the inside.

The profiling of the roll W₃ (not represented here) may then also be formed in a way corresponding to the profiling of the roll W₁ and/or W₂, see FIG. 1.

In order that the extruded and conically tapered panels 6 that are transferred onto the roller conveyor 4 can be transported there equally well, the corresponding rollers 5 of the roller conveyor 4 may also be formed in a profiled manner in a way corresponding to the profile of the panels 6.

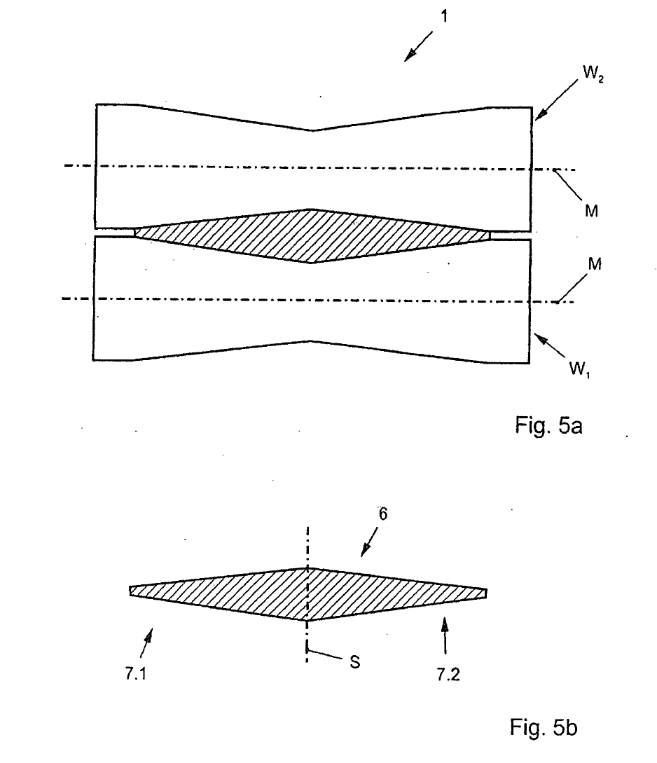

In order for example to extrude conically extending panels 6, as represented in FIG. 2b, the rolls W₁ and W₂ can be respectively profiled, according to FIG. 5a, so that the tapered conically extending regions 7.1, 7.2 lie in the end region, see FIG. 5b. This creates panels 6 that are formed in a profiled manner on both sides, on the upper side and on the underside. The angles α which the panels 6 include, see FIGS. 2a and 2b, may be only a few degrees, such as for example α=0.05 of a degree.

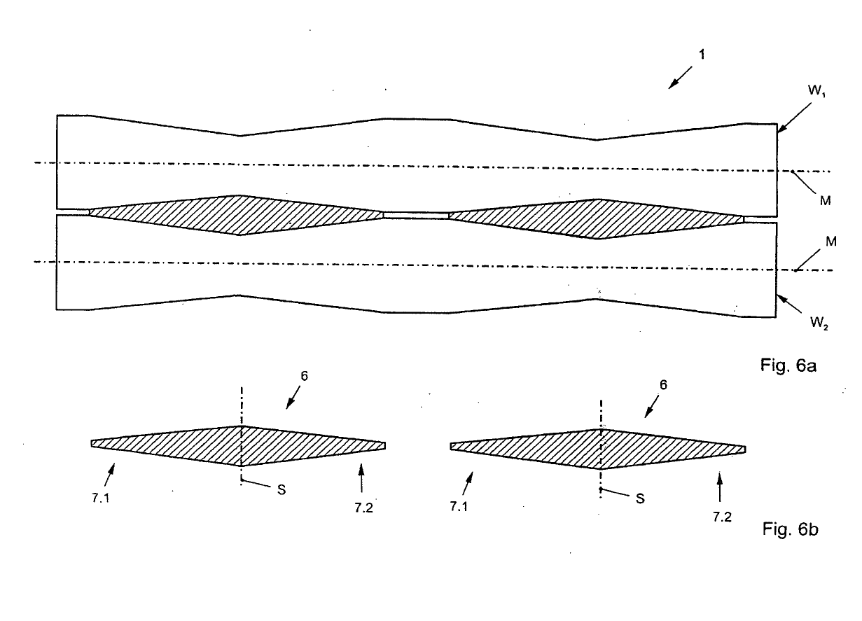

In the exemplary embodiment of the present invention according to FIG. 6, in the axial direction of the rolls 5 a number of profilings are provided lying opposite one another on the rolls W₁ and/or W₂, in order to produce a number of panels 6, as also represented more specifically in FIGS. 5b and 6b, simultaneously in parallel. The rolls W₁ and/or W₂ may, however, also have the profilings described above, according to FIGS. 3a, 4a and 5a. The invention is not restricted to this.

Furthermore, it is important in the case of the present invention, not represented any more specifically, that the extrusion die 2, see FIG. 1, also has an outlet cross section (not represented any more specifically here) which corresponds to the cross section of the panels 6 or of the profiled roll W₁ and/or W₂. In this way, a volume flow or outlet volume of the extruded thermoplastic synthetic material 3 can also be adapted to the cross-sectional form of the panels 6. This is of importance in particular for evening out the flow rates of the heated thermoplastic synthetic material 3.

Furthermore, it has proven to be advantageous in the case of the present invention that different temperatures can be set in the die body of the extrusion die 2, in order to influence the flow rate of the plastically extruded synthetic material 3. In this respect, in thicker regions of the panel 6 the region in the die body is heated to a higher temperature than the regions that are for example thinner and run out conically. In this way, the outlet rate or the volume flow during extrusion can be evened out.

This also allows internal stresses to be reduced or avoided, warping of the panels 6 also being reduced or prevented.

In order furthermore to obtain a very high surface quality, and additionally reduce internal stresses, the panels 6, or the thermoplastically extruded synthetic material, is/are cooled in the polishing stack 1 at the rolls W₁ to W₃. In this respect, the cooling may be performed to a greater degree in particular in the cross-sectionally thicker regions of the panels 6 than in the conically tapered regions 7.1, 7.2.

Irrespective of whether they are lying on the inside or on the outside, the cooling is performed to a lesser degree in the conically tapered regions, or it is even intended to consider re-heating or additional heating of these regions, in order to cool a panel 6 homogeneously and evenly over the entire cross section, in order to obtain a high surface quality along with low internal stresses.

### LIST OF ITEM NUMBERS

| | |
|---|---|
| 1 | polishing stack |
| 2 | extrusion die |
| 3 | synthetic material |
| 4 | roller conveyor |
| 5 | Roll |
| 6 | panels |
| 7 | region |
| 8 | |
| 9 | |
| 10 | |
| 11 | |
| 12 | |
| 13 | |
| 14 | |
| 15 | |
| 16 | |
| 17 | |
| 18 | |
| 19 | |
| 20 | |
| 21 | |
| 22 | |
| 23 | |
| 24 | |
| 25 | |
| 26 | |
| 27 | |
| 28 | |
| 29 | |
| 30 | |
| 31 | |
| 32 | |
| 33 | |
| 34 | |
| 35 | |
| 36 | |
| 37 | |
| 38 | |
| 39 | |
| 40 | |
| 41 | |
| 42 | |
| 43 | |
| 44 | |
| 45 | |
| 46 | |
| 47 | |
| 48 | |
| 49 | |
| 50 | |
| 51 | |
| 52 | |
| 53 | |
| 54 | |
| 55 | |
| 56 | |
| 57 | |
| 58 | |
| 59 | |
| 60 | |
| 61 | |
| 62 | |
| 63 | |
| 64 | |
| 65 | |
| 66 | |
| 67 | |
| 68 | |
| 69 | |
| 70 | |
| 71 | |
| 72 | |
| 73 | |
| 74 | |
| 75 | |
| 76 | |
| 77 | |
| 78 | |
| 79 | |
| α | angle |
| R | apparatus |
| M | central axis |
| S | cutting location |
| W₁ | roll |
| W₂ | roll |
| W₃ | roll |

1-25. (canceled)

26. A method for producing panels of thermoplastically extruded synthetic materials for TFT screens, comprising conically extruding the panels.

27. The method as claimed in claim 26, wherein the step of conically extruding the panels comprises conically extruding the panels in a polishing stack.

28. The method as claimed in claim 26, wherein the steps of conically extruding the panels comprises conically extruding the panels in a three roll polishing stack.

29. The method as claimed in claim 26, further comprising passing thermoplastically extruded synthetic material from an extrusion die between a first and a second roll with at least one of the two rolls or their lateral surfaces being formed in a conically profiled manner in a way corresponding to a form of the panels to be conically extruded.

30. The method as claimed in claim 29, further comprising providing at least one of said rolls with a conical profile.

31. The method as claimed in claim 26, further comprising conically extruding two conically opposed panels simultaneously.

32. The method as claimed in claim 29, further comprising providing an extrusion die having an extrusion die cross section which approximately corresponds cross-sectionally to a cross section of the panels to be conically extruded.

33. The method as claimed in claim 29, further comprising providing an extrusion die having a conically formed cross section and aligning said cross section with at least one conically formed profile of at least one of said rolls of a polishing stack.

34. The method as claimed in claim 29, further comprising adapting an outlet cross section of the extrusion die or an outlet volume of the extrusion die to the conical form of at least one of said rolls of a polishing stack.

35. The method as claimed in claim 34, further comprising setting different temperatures in a die body of the extrusion die in dependence on a conical form of the at least one roll and/or of the outlet cross section, in order to homogenize an entire outlet rate in response to different flow rates resulting from different outlet cross sections.

36. The method as claimed in claim 26, further comprising subjecting the conically extruded panels to different temperature control in different regions.

37. The method as claimed in claim 26, further comprising heating the conically extruded panels to a greater degree than in thinner regions.

38. The method as claimed in claim 26, further comprising cooling the conically extruded panels in a polishing stack in cross-sectionally thicker regions.

39. The method as claimed in claim 38, further comprising subjecting the conically extruded panels to less cooling in the polishing stack in cross-sectionally thinner regions and optionally heating in these regions.

40. The method as claimed in claim 36, wherein said subjecting step comprises to ensure homogeneous cooling of a conically extruded panel to reduce internal stresses, and to avoid instances of warping and ensure a high surface quality, cross-sectionally different of said panel cooling in thicker regions and optionally less cooling or re-heating of said panel in a polishing stack cross-sectionally as a whole.

41. The method as claimed in claim 26, further comprising passing the panels conically emerging from a polishing stack on to a roller conveyor which is profiled in a way corresponding to the cross-sectional form of the panels.

42. The method as claimed in claim 41, further comprising profiling individual rollers of the roller conveyor in a way corresponding to the conically formed panels.

43. The method as claimed in claim 26, further comprising extruding two conically extending panels together in one panel, aligning respectively conically running-out regions such that they are opposed, and, after the panel has been produced with two conically extending regions, dividing the panels in a region of a cutting location.

44. An apparatus for extruding panels of thermoplastically extruded synthetic materials comprising an extrusion die and a polishing stack following on after the extrusion die, and at least one roll of the polishing stack being formed in a profiled manner for the extrusion of a conical panel.

45. The apparatus as claimed in claim 44, wherein the at least one roll of the polishing stack has two conically running-out regions, which are formed in an outer lateral surface of the at least one roll.

46. The apparatus as claimed in claim 44, wherein the polishing stack has two opposed rolls with corresponding profilings in line with one another, and outwardly in-line conical regions being formed in each said profiling.

47. The apparatus as claimed in claim 46, further comprising an outlet cross section of the extrusion die is made to match approximately the cross section of the profiling of at least one of said rolls or of the profilings of two adjacent ones of said rolls.

48. The apparatus as claimed in claim 46, wherein in dependence on a thickness of the profiling of the at least one of said rolls or of the conical region, corresponding heating devices are provided in a die body of the extrusion die for different temperature control of regions of different thickness, and means for controlling an outlet temperature that is higher in thicker regions than in thinner regions.

49. The apparatus as claimed in claim 44, further comprising after the conically extruded panel has emerged from the extrusion die in the polishing stack, means for performing cooling to a greater degree, or if need be additional cooling, of the extruded synthetic material in cross-sectionally thicker regions than in thinner regions, and means for performing re-heating or additional heating if need be in thinner regions.

50. The apparatus as claimed in claim 44, further comprising after the polishing stack a roller conveyor, and the rollers of said conveyor being made to match the conical panel or the profiled form of the panel.

51. The apparatus as claimed in claim 43, further comprising on one or two adjacent rolls a plurality of regions being formed conically one after the other in an axial direction and being provided next to one another for the production of a number of panels.
